(19) United States
(12) Patent Application Publication
(10) Pub. No.: US 2023/0075710 A1
(43) Pub. Date: Mar. 9, 2023

(54) METHOD OF DUST SUPPRESSION FOR CRUSHERS WITH SPRAYING DEVICES

(71) Applicant: Rubble Master HMH GmbH, Linz (AT)

(72) Inventors: Christian Hinterdorfer, Gutau (AT); Christian Hinterreiter, Obergrünburg (AT)

(21) Appl. No.: 17/800,041

(22) PCT Filed: May 10, 2021
(86) PCT No.: PCT/AT2021/060165

§ 371 Date: Aug. 16, 2022

(30) Foreign Application Priority Data
May 13, 2020 (AT) A50421/2020

(51) Int. Cl. B02C 25/00; B02C 23/18; G05B 13/02; G06T 7/00; G06T 7/593; G06T 7/62

(52) U.S. Cl. CPC B02C 25/00; B02C 23/18; G05B 13/027; G06T 7/0004; G06T 7/593; G06T 7/62; G06T 2207/10012; G06T 2207/10028; G06T 2207/20084; G06T 2207/20081

(57) ABSTRACT

A method of dust suppression for crushers (2) with spraying devices (3) is described. To facilitate a resource-sparing dust suppression independently of the operator and even in the case of heterogeneous bulk material, the deviation between an image representation recorded by a first sensor (4) of a pattern arranged in its detection region as an actual value and a specified target value is determined, whereupon the spraying devices (3) assigned to the pattern are activated if the deviation exceeds a specified threshold.

### FIELD OF THE INVENTION

The invention relates to a method of dust suppression for crushers with spraying devices. The method can also be used, for example, with screens or other bulk material processing equipment.

### DESCRIPTION OF THE PRIOR ART

It is known from the prior art to bind dust particles occurring during the crushing of bulk material with a binder, for example water, whereby a sedimentation of the dust particles is favored and a dust emission can be reduced. For this purpose, crushers used for crushing the bulk material have spraying devices at points of increased dust loading, which spray the binder. Usually, the binder is sprayed continuously, but this leads to unnecessary consumption of binder in some cases, especially when hardly any dust is generated during crushing of the bulk material. Therefore, in order to be able to react to the varying dust load associated with the crushing of different bulk materials, it is known, especially in mobile crushers, to activate and deactivate the spraying devices manually. This task is usually performed by the operator of the mobile crusher. The disadvantage of this is that the decision to activate depends on the subjective perception of the operator, who must also enter the area of increased dust exposure. Regardless of whether a continuous or manually controlled input of the binder takes place, the spraying devices known from the prior art are fed via a central binder supply so that all spraying devices spray the same amount of binder. Manual activation of all spraying devices also has the disadvantage that the function of an optical detection device for the bulk material, for example for crusher control, is impaired by the subjective assessment of the operator. For example, the operator may cause a multiple of the actually required amount of binder to be sprayed, which disturbs the function of the optical detection unit. Such excessive binder application is also associated with the problem that weighing values of the bulk material are distorted or the bulk material must be subjected to a drying process before weighing. Conversely, if too little binder is fed in, the optical detection unit may also be disturbed by dust formation.

CN204208659U describes a method of dust suppression for crushers with a spraying device. The spraying device, which is aligned with the crushing gap, is activated by a sensor when the latter detects an actual value that is above a specified threshold value of a dust concentration. A similar method is known from CN209791618, wherein an inductive sensor is provided as the sensor. A disadvantage of these methods is the high binder requirement, irrespective of the actual demand.

### SUMMARY OF THE INVENTION

The invention is thus based on the object of improving a method of the type described at the beginning in such a way that, independently of the operator, a resource-saving and effective dust suppression can be made possible even with heterogeneous bulk material.

The invention solves the set object by determining the deviation between an image, recorded by a first sensor, of a pattern arranged in its detection region as an actual value and a specified target value, whereupon, when the deviation exceeds a specified threshold value, the spraying devices associated with the pattern are activated. As a result of these measures, areas of increased dust loading can be localized and only those spraying devices can be used to introduce a binder, for example water, which are assigned to the localized area and are therefore suitable for dust suppression of the localized area of increased dust loading. For localization, a pattern may be provided in the detection region of the sensor. This pattern is recorded by the sensor and mapped as an actual value. The actual value is compared with a known target value of the pattern, which is stored on a control unit, for example. An increased dust load leads to a change in the image, resulting in a deviation between the actual value and the stored target value. As soon as the deviation exceeds a predefined threshold value, the spraying device assigned to the pattern is activated, whose delivered binder wets the dust particles and thus promotes sedimentation of the dust particles. Particularly when optical sensors are used, the geometric shape of a QR code or of a machine element fixed in the detection region can be used as a pattern, whereby a comparison between the actual value and the target value can be made largely independent of the light conditions in the detection region. Any incorrect adjustment due to the lighting conditions can also be prevented if the target value can be adapted to different brightness levels to be expected in the detection region. The adjustment can, for example, be made depending on a light sensor. The assignment between a pattern and a spraying device can be made as a function of the distance of the various spraying devices from the pattern, so that as a rule the spraying device closest to the pattern and/or the spraying device upstream with respect to the bulk material flow are activated. However, the sensor and the spraying devices can also be connected to a control unit, enabling more complex control. Thus, optionally, for dust suppression in a particularly large localized area, several spraying devices upstream of this area can be activated in order to avoid interference with the first sensor in this area. After activation of the spraying device, the control unit can check the effectiveness of the dust suppression carried out by determining the size of the deviation after injection of the binder and varying the assignment of the spraying devices to the pattern and/or the amount of binder added as a function of this deviation. This control can be used to optimize dust suppression. Deactivation of the spraying device takes place after a specified amount of the binder has been dispensed. The predefined quantity can, for example, be a fixed volume, or it can vary depending on the size of the deviation between the actual and target values. If there is a particularly large exceedance of the threshold value, for example, an increased volume flow can be provided by the corresponding spraying device of the binder. To vary the volume flow, the spraying devices can have solenoid valves.

In principle, it is conceivable that an optical sensor is assigned to each pattern, which results in a correspondingly high cost if a large number of patterns are involved. In order to enable precise control of the dust suppression despite a simple and cost-effective measurement setup, it is proposed that images of several patterns are captured simultaneously by the first sensor. In this case, several patterns are arranged at reference points in the detection region of the first sensor, whereby a differentiated assignment of spraying devices can take place without having to assign a sensor to each pattern for this purpose. A suitable sensor for this purpose is, for example, a wide-angle camera that has the widest possible detection region.

During the mechanical crushing of bulk material, machine elements of the crusher are usually subject to heavy wear. As a result, the patterns arranged on the crusher or machine elements serving as patterns can also be worn and therefore falsified, which can lead to an incorrect matching between the actual value and the target value of a pattern. Therefore, in order to be able to perform the control independently of patterns arranged in a fixed manner in the detection space, the image of the pattern recorded by a second sensor can form the target value and the deviation can be determined as the number of non-corresponding pattern points in the target value and actual value. Thus, in this case, the target value is not permanently stored on a control unit, but is continuously recorded by a second sensor. The pattern can comprise a series of pixels that can be identified both in the image of the first sensor and in the image of the second sensor and assigned as corresponding pattern points between the images. The first and second sensors must have a different angle of detection with respect to the pattern for this purpose, but this is the case anyway when both sensors are spaced apart and both are aligned with the pattern to capture the image. Known photogram metric methods can be used to identify and assign the pixels. This results in the advantage that the patterns do not have to be rigidly arranged in the detection space of the sensors, but can be, for example, moving bulk material. Accordingly, the sensors for the detection of the dust load can also be used for the optical assessment of the bulk material, which enables not only a control of the dust suppression, but also of the entire preparation process of bulk material, for example the comminution process or the classification. The comparison of the actual value with the target value is carried out by matching the pattern points of the actual value with the corresponding points of the target value. In this case, a threshold value of the deviation is exceeded if a certain number of corresponding pattern points cannot be assigned.

Particularly practical control conditions arise when data are used to determine the deviation between the actual value and the target value, which are necessary anyway to control the processing of bulk material. Such data can be, for example, depth data, which can be used to assess the nature of the bulk material, for example to classify particle sizes of the bulk material. For this purpose, the first and second sensors may form a stereo camera. Stereo cameras are used to acquire depth data of the bulk material, which can subsequently be used to determine the nature of the bulk material. The depth data is in turn generated by matching corresponding pattern points. In this case, the number or proportion of missing depth data can be used as a deviation.

While determining the deviation between the actual value and a stored target value of a pattern is extremely sensitive, determining the deviation between the actual value detected by the first sensor and the target value detected by the second sensor proves to be a particularly robust method, since this method is largely independent of the lighting conditions in the detection region. To combine the advantages of both options, an optical camera and a stereo camera can be provided as sensors.

In order that the method can be further improved in terms of resource conservation with the aid of material-specific data of the bulk material without increasing the measurement or design effort, it is proposed that a two-dimensional depth image of bulk material conveyed past the stereo camera is generated with the stereo camera and fed to a pre-trained convolutional neural network which has at least three successive convolution layers and a downstream quantity classifier for each class of a particle size distribution, the output values of which are output as a particle size distribution. The information of the determined particle size distribution can be used to control the dust suppression. If the particle size distribution is shifted in the direction of smaller particle sizes, then in combination with, for example, an increased power requirement of the crusher, an intensive crushing process and thus an increased dust load can be concluded, whereby the amount of binder sprayed for dust suppression can be increased. The particle size distribution is thereby a histogram, which can be formed either with absolute quantity values or with relative quantity values related to the bulk material volume, and thus provides important conclusions, for example about the crushing gap, any disturbances or other process parameters of a crusher. Thus, the measures according to the invention allow the screening curve of crushers with high speeds, which can conventionally only be determined with great effort, to be recorded automatically, since no parameters have to be recorded for individual grains and relevant quantities calculated from them. The determination of the particle size distribution directly from the depth image thus also reduces the susceptibility to errors when determining the particle size distribution. In order to compensate for fluctuations in the acquisition of the particle size distribution and to compensate for erroneous output values of the neural network, several successive output values can also be averaged and the average value can be output as the particle size distribution of the bulk material present in the detection region.

The training of the neural network requires large quantities of training depth images that represent the bulk material to be detected as accurately as possible. However, the amount of work required to measure the necessary amount of bulk material is extremely high. In order to provide the neural network with sufficient training depth images to determine the bulk material volume, it is suggested to first acquire sample depth images of one sample grain each with a known volume and to store them together with the volume, after which several sample depth images are randomly combined to a training depth image, to which the sum of the volumes of the composite example depth images and/or the class-wise distribution of the bulk material volumes of the composite example depth images is assigned as bulk material volume, whereupon the training depth image is fed to the neural network on the input side and the assigned bulk material volume and/or the assigned particle size distribution is fed to the neural network on the output side, and the weights of the individual network nodes are adapted in a learning step. The training method is thus based on the consideration that manifold combinations of training depth images can be created by combining example depth images of measured bulk material grains. Thus, it is sufficient to acquire example depth images of relatively few bulk material grains with their volume in order to generate a large number of training depth images with which the neural network can be trained. To train the neural network, the weights between the individual network nodes are adjusted in a known manner in the individual training steps so that the actual output value corresponds as closely as possible to the specified output value at the end of the neural network. Different activation functions can be specified at the network nodes, which are decisive for whether a sum value present at the network node is passed on to the next level of the neural network. Analogous to the volume, other parameters, such as the particle size distribution of the grains mapped in the example depth image, can also be assigned to the example depth images. For depth image processing, it is also proposed here that the values of those pixels whose depth corresponds to or exceeds a pre-detected distance between the stereo camera and the background for that pixel are removed from the depth image. As a result, the training depth images and the depth images of the measured material have only the information relevant for the measurement, which results in a more stable training behavior and increases the recognition rate in the application. By selecting the example depth images or the training depth images composed of them, the neural network can be trained on any type of bulk material.

Training the neural network becomes more difficult and the measuring accuracy decreases during operation if elements foreign to the bulk material lie within the detection region of the stereo camera. These include, for example, vibrating components of a conveyor belt itself, or other machine elements. To avoid the resulting disturbances, it is suggested that the values of those pixels are removed from the depth image whose depth corresponds to a previously detected distance between the stereo camera and a background for this pixel or exceeds this distance. In this way, interfering image information, caused for example by vibrations of the conveyor belt, can be removed and both the depth images and the training depth images can be limited to the information relevant for the measurement.

The problem frequently arises that the bulk material wetted by the binder leads to falsified weighing values due to the additional mass of the binder. Therefore, in order to enable a valid determination of the nature, in particular the mass, of the wetted bulk material without having to subject the bulk material to a drying process beforehand, it is proposed that a volume classifier is placed downstream of the convolution layers and that the output value of the volume classifier is output as the bulk material volume present in the detection region. As a result of these measures, it is therefore possible to determine the mass of the bulk material with a known density of the dry bulk material, since the binder does not contribute to the determined volume of the bulk material. For this purpose, no scales are required, but only the stereo camera used for determining the volume of the bulk material, which is used anyway for controlling the dust suppression. The underlying consideration is that when two-dimensional depth images are used, the information required for volume determination can be extracted from the depth information after a neural network used for this purpose has been trained with training depth images with a known bulk material volume. The convolution layers reduce the input depth images to a series of individual features, which in turn are evaluated by the downstream volume classifier, so that the total volume of the bulk material depicted in the input depth image can be determined as a result. The volume therefore no longer has to be calculated for each individual grain. Since the distance of the imaged bulk material to the stereo camera is mapped with only one value per pixel in the depth image, the amount of data to be processed can be reduced in contrast to the processing of color images, the measuring procedure can be accelerated and the memory requirement necessary for the neural network can be reduced. As a result, the neural network can be implemented on inexpensive AI parallel computing units with GPU support and the method can be used regardless of the color of the bulk material. Also, the bulk material volume can be determined by accelerating the measurement method even at conveyor belt speeds of 3 m/s, preferably 4 m/s. The aforementioned reduction in the amount of data in the depth image and thus in the neural network additionally reduces the susceptibility to errors for the correct determination of the bulk material volume. In contrast to color or grayscale images, the use of depth images has the additional advantage that the measurement procedure is largely independent of changing exposure conditions. For example, a vgg16 network (Simonyan/Zisserman, Very Deep Convolutional Networks for Large-Scale Image Recognition, 2015), which is usually only used for color images, can be used as a neural network, which is reduced to only one channel, namely for the values of the depth pixels. Furthermore, in order to compensate for variations in the detection of the volume and to compensate for erroneous output values of the neural network, several successive output values can be averaged and the average value can be output as the bulk material volume present in the detection region.

To further improve the training behavior and recognition rate, it is proposed that the sample depth images are assembled with random orientation to form a training depth image. Thus, for a given number of bulk grains per example depth image, the number of possible arrangements of bulk grains is significantly increased without the need to generate more example depth images and overfitting of the neural network is avoided.

Separation of the bulk material grains of the bulk material can be omitted and larger bulk material volumes can be determined at a constant conveying speed of the conveyor belt if the example depth images are combined with partial overlaps to form a training depth image, wherein the depth value of the training depth image in the overlap area corresponds to the smallest depth of both example depth images. In order to capture realistic bulk material distributions, the cases in which two bulk material grains come to rest on top of each other must be taken into account. The neural network can be trained to detect such overlaps and still determine the volume of the bulk material grains.

### BRIEF DESCRIPTION OF THE INVENTION

In the drawing, the subject matter of the invention is shown by way of example, wherein:

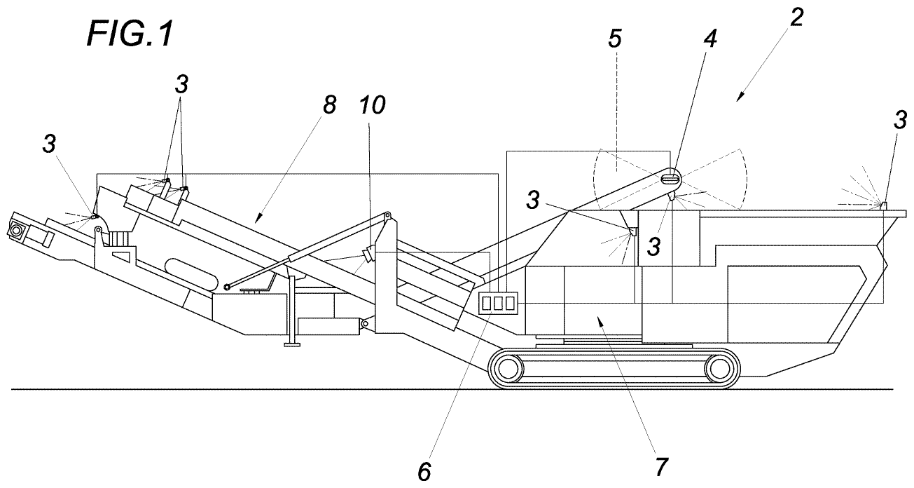

FIG. 1 shows a side view of a mobile crusher on which the method according to the invention is applied, and

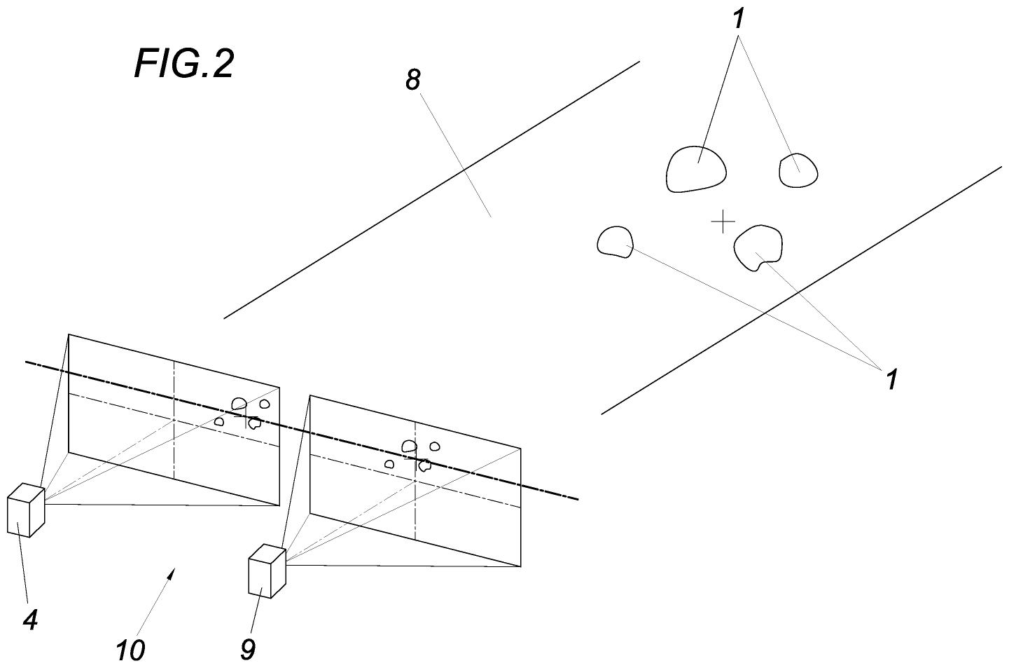

FIG. 2 shows a schematic representation of an alignment of corresponding pattern points of bulk material by a stereo camera.

### DETAILED DESCRIPTION OF THE PREFERRED EMBODIMENTS

A method according to the invention can be used, for example, for dust suppression of dust particles produced during crushing of bulk material 1. For this purpose, a mobile crusher 2 used for this purpose and shown in FIG. 1 has spraying devices 3. In order to enable a resource-saving dust suppression, the spraying devices 3 are activated only in case of an increased dust load. The assessment of whether an increased dust load is present is made by a first sensor 4, which detects a pattern arranged in its detection region 5 and compares the image of the pattern as an actual value with a target value stored on a control unit 6. If a deviation exceeding a certain threshold value is detected between the actual value and the target value of the pattern, only the spraying devices 3 assigned to this pattern are activated. The spraying devices 3 subsequently emit a binder to bind the dust particles until they are deactivated. To enable the spraying devices 3 to be activated in as differentiated a manner as possible, several patterns can be arranged at representative locations in the crusher. Such locations may not be provided in the crushing chamber 7, but may be provided at the beginning or end of the conveyor belt 8 or at locations which are necessary for the visual assessment of the condition of the bulk material 1. The assignment of the spraying devices 3 to the patterns can be made in dependence on the distance of the spraying devices 3 to the patterns, so that a deviation of a certain pattern exceeding a threshold value activates the closest spraying device 3. However, it is also conceivable that the spraying devices 3 and the first sensor 4 are connected to a control device 6, which can continuously optimize the control of the dust suppression by a parameter variation, for example a varying assignment of the spraying devices 3 to a certain pattern or varying binder quantities delivered by the spraying devices 3. In principle, the spraying devices 3 are arranged on the crusher 2 in such a way that they enable comprehensive dust suppression, especially in the relevant areas of increased dust loading.

In order to reduce the measurement and maintenance effort, several patterns can be arranged in the detection region 5 of the first sensor 4. This means that a large number of patterns can be detected with just one optical sensor 4, enabling differentiated and thus efficient activation of the spraying devices 2 arranged at different positions. A wide-angle or 360° camera, for example, is suitable as the first sensor 4 for this purpose.

FIG. 2 shows the possibility that the bulk material 1 itself can also be used as a sample for assessing the prevailing dust load. This is made possible in that the image of the bulk material 1 recorded by a second sensor 9 serves as a target value. The target value is therefore not permanently stored on a control unit 6, but is continuously re-recorded. The deviation between the actual value recorded by the first sensor 4 and the target value recorded by the second sensor 9 corresponds to the number of non-corresponding pattern points between the actual and target values.

The first sensor 4 and the second sensor 9 can form a stereo camera 10, whereby, in addition to detecting the dust load in the area of the stereo camera 10, information about the depth data can also be acquired, which can subsequently be used to assess the condition of the bulk material 1.

As disclosed in FIG. 1, both an optical camera 4 and a stereo camera 10 may be provided as sensors.

1. A method of dust suppression for a crusher with spraying devices, said method comprising:
recording an image with a first sensor of a pattern arranged in a detection region such that said image serves as an actual value, and
determining a deviation between the actual value and a specified target value; and
when the deviation exceeds a specified threshold value, activating the spraying devices associated with the pattern.

2. The method according to claim 1, wherein the method further comprises detecting images of several patterns simultaneously with the first sensor.

3. The method according to claim 1, wherein an image of the pattern recorded by a second sensor is the target value, and the deviation is determined as a number of non-corresponding pattern points in the target value and the actual value.

4. The method according to claim 3, wherein the first sensor and the second sensor form a stereo camera.

5. The method according to claim 4, wherein the method further comprises generating with the stereo camera a two-dimensional depth image of bulk material conveyed past the stereo camera and feeding the two-dimensional depth image to a previously trained convolutional neural network that has at least three convolution layers arranged one behind the other and, for each class of a particle size distribution, a downstream quantity classifier, output values thereof being output as a particle size distribution.

6. The method according to claim 5, wherein the depth image comprises pixels each having a respective value, and the method comprises removing from the depth image the values of the pixels that have a depth that corresponds to, or exceeds, a previously detected distance between the stereo camera and a background for the pixel.

7. The method according to claim 5, wherein a volume classifier is arranged downstream of the convolution layers, and an output value of the volume classifier is output as a volume of the bulk material present in the detection region.

8. A training method for training a neural network for the method according to claim 5, said training method comprising:
first acquiring example depth images of a respective example grain with a known volume and storing said depth images together with the known volume thereof;
combining a plurality of example depth images randomly so as to form a training depth image to which a sum of the known volumes of the composite example depth images is assigned as bulk material volume or a class-wise distribution of bulk material volumes of the composite example depth images is assigned as the particle size distribution; and
feeding the training depth image to the neural network on an input side thereof and feeding the assigned bulk material volume or the assigned particle size distribution is fed to the neural network on an output side thereof; and
adapting weights of individual network nodes of the neural network in a learning step.

9. The method according to claim 2, wherein an image of the pattern recorded by a second sensor is the target value, and the deviation is determined as a number of non-corresponding pattern points in the target value and the actual value.

10. The method according to claim 9, wherein the first sensor and the second sensor form a stereo camera.

11. The method according to claim 10, wherein the method further comprises generating with the stereo camera a two-dimensional depth image of bulk material conveyed past the stereo camera and feeding the two-dimensional depth image to a previously trained convolutional neural network that has at least three convolution layers arranged one behind the other and, for each class of a particle size distribution, a downstream quantity classifier, output values thereof being output as a particle size distribution.

12. The method according to claim 11, wherein the depth image comprises pixels each having a respective value, and the method comprises removing from the depth image the values of the pixels that have a depth that corresponds to, or exceeds, a previously detected distance between the stereo camera and a background for the pixel.

13. The method according to claim 11, wherein a volume classifier is arranged downstream of the convolution layers, and an output value of the volume classifier is output as a volume of the bulk material present in the detection region.

14. The method according to claim 12, wherein a volume classifier is arranged downstream of the convolution layers, and an output value of the volume classifier is output as a volume of the bulk material present in the detection region.

15. The method according to claim 6, wherein a volume classifier is arranged downstream of the convolution layers, and an output value of the volume classifier is output as a volume of the bulk material present in the detection region.
